(19) United States
(12) Patent Application Publication
(10) Pub. No.: US 2008/0082662 A1
(43) Pub. Date: Apr. 3, 2008

(54) Method and apparatus for controlling access to network resources based on reputation

(76) Inventors: Richard Dandliker, Oakland, CA (US); Shalabh Mohan, Mountain View, CA (US); Ambika Gadre, Menlo Park, CA (US); Jed Lau, San Francisco, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/804,017

(22) Filed: May 15, 2007

Related U.S. Application Data
(60) Provisional application No. 60/802,033, filed on May 19, 2006.

(51) Int. Cl. G06F 15/16

(52) U.S. Cl. 709/225

(57) ABSTRACT

Access to network resources is controlled based on reputation of the network resources. In an embodiment, a data processing apparatus is coupled to a first protected network and to a second network, and comprises logic configured to cause receiving a client request that includes a particular network resource identifier; retrieving, from a database that associates a plurality of network resource indicators with attributes of the network resource identifiers, values of particular attributes that are associated with the particular network resource identifier; determining a reputation score value for the particular network resource identifier based on the particular attributes; and performing a responsive action for the client request based on the reputation score value.

### PRIORITY CLAIM; CROSS-REFERENCE TO RELATED APPLICATION

This application claims the benefit under 35 U.S.C. §119(e) of provisional application 60/802,033, filed May 19, 2006, the entire contents of which are hereby incorporated by reference as if fully set forth herein. This application is related to application Ser. No. 11/742,015, filed Apr. 30, 2007, and application Ser. No. 11/742,080, filed Apr. 30, 2007.

### TECHNICAL FIELD

The present disclosure generally relates to data processing apparatus and methods that control access to network resources such as Internet sites. The disclosure relates more specifically to techniques for controlling access to network resources based on metadata.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Business organizations are facing a growing problem of managing the flow of information between their employees and the outside world. Over the last decade, the explosive growth of the Internet has dramatically improved access to important business information and provided new ways to bolster the efficacy of communications. Browsing online sites that are part of the “World Wide Web” (“web”), electronic document and file transfers, and multimedia presentations have all become critical parts of many businesses.

However, access to the web and other Internet resources has opened up users and networks to new security threats. Spyware, virus, and phishing attacks have all been growing in prevalence and sophistication. Some network resources such as Web sites are configured by malicious or dishonest persons to host viruses, spyware, adware, or other harmful computer program code (“malware”), or to contain forms or applications that seek to collect personal identifying information or financial account information for unauthorized purposes. The persons who control such sites often seek to entrap unsuspecting users into giving up personal financial information by sending electronic mail (e-mail) messages to the users that appear to originate from legitimate entities, and contain hyperlinks to the malicious or dishonest sites. Network security analysts use the term “phishing” to describe such approaches.

Past solutions to web security threats generally have been based on reactive technology; that is, they respond to new and different threats once those threats have been discovered and analyzed. Uniform resource locator (URL) blacklists are effective at blocking sites with known threats, but updating the blacklists can be difficult and resource intensive, due to the large number of possible sites that need to be checked individually. Signature-based solutions are also effective for detecting and stopping known malware, but these are computationally intensive and inadequate in the face of new threats. Heuristic algorithms based on content analysis can help as well, but can suffer from false positives and can be fooled by clever malware developers. Thus, new solutions are needed in web security to combat the changing nature of threats.

Hypertext transfer protocol (HTTP) and simple mail transfer protocol (SMTP) are defined in Internet Engineering Task Force (IETF) Request for Comments (RFC) 2616 and RFC 2821. The reader of this document is presumed to be familiar with RFC 2616, RFC 2821, and the structure of an HTTP request, a URL, a hyperlink, and an HTTP proxy. Generally, an HTTP request is an electronic message that conforms to HTTP and that is sent from a client or server to another server to request a particular electronic document, application, or other server resource. An HTTP request comprises a request line, one or more optional headers, and an optional body. A URL identifies a particular electronic document, application or other server resource and may be encapsulated in an HTTP request. A hyperlink is a representation, in an electronic document such as an HTML document, of a URL. Selecting a hyperlink invokes an HTTP element at a client and causes the client to send an HTTP request containing the URL represented in the hyperlink to an HTTP server at, and identified by, a domain portion of the URL.

### BRIEF DESCRIPTION OF THE DRAWINGS

In the drawings:

FIG. 1 is a block diagram that illustrates an overview of a system that can be used to implement an embodiment.

FIG. 2 is a flow diagram that illustrates a high level overview of one embodiment of a method for determining URL reputation values.

FIG. 3A is a flow diagram that illustrates a high level overview of one embodiment of a method for controlling access to network resources based on reputation.

FIG. 3B is a flow diagram that illustrates example control actions.

FIG. 3C illustrates an example process of determining a reputation score value.

FIG. 4 is a block diagram that illustrates a computer system upon which an embodiment may be implemented.

FIG. 5 is a block diagram of a logical organization of a system for controlling access to network resources based on reputation.

FIG. 6 is a block diagram of a logical organization of a system for controlling access to network resources based on reputation.

### DETAILED DESCRIPTION

A method and apparatus for controlling access to network resources based on reputation is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
3.0 Example Processing and Architecture
   3.1 System Overview
   3.2 Determining URL Reputation Values
   3.3 Controlling Access Based on Reputation
   3.4 Example System Architecture Details
4.0 Implementation Mechanisms-Hardware Overview
5.0 Extensions and Alternatives

1.0 General Overview

In an embodiment, access to network resources is controlled based on reputation of the network resources. In an embodiment, a data processing apparatus is coupled to a first protected network and to a second network, and comprises logic configured to cause receiving a client request that includes a particular network resource identifier; retrieving, from a database that associates a plurality of network resource indicators with attributes of the network resource identifiers, values of particular attributes that are associated with the particular network resource identifier; determining a reputation score value for the particular network resource identifier based on the particular attributes; and performing a responsive action for the client request based on the reputation score value.

In an embodiment, the client request is an HTTP request, and the network resource identifier is a URL. In an embodiment, the responsive action comprises denying access to a resource that is identified in the network resource identifier. In an embodiment, the responsive action comprises performing one or more other tests on resources or network resource identifiers.

In an embodiment, the apparatus further comprises an HTTP proxy and an e-mail server.

In an embodiment, the logic further comprises instructions which when executed cause performing determining the reputation score value by providing the particular network resource identifier to a reputation service; receiving a plurality of prefix reputation score values for each of a plurality of prefixes that form parts of the network resource identifier; determining the reputation score value by combining and weighting the received prefix reputation score values.

The description and claims herein disclose many other features, aspects and embodiments. For example, in other aspects, the invention encompasses methods and a computer-readable medium configured to carry out the functions of elements that are shown and described herein.

Thus, embodiments provide effective mechanisms for addressing threats carried in URLs and other network resource identifiers. Embodiments address a problem that is quite different from the problem of spam carried in e-mail. For example, whereas the vast majority of e-mail is bad, the vast majority of URLs are good. Unlike e-mail, in which false negatives (spam marked as ham) are preferred to false positives (ham marked as spam), URL false positives (safe URLs that are blocked/warned) are preferred to URL false negatives (bad URLs that are allowed). Further, whereas a large spam corpus can be used to train a Bayesian anti-spam system, a much smaller corpus of spyware URLs exists. Anti-spam methods scan e-mail message bodies for spam. Analogously, anti-spyware (ASW) engines scan HTTP responses for spyware.

A corollary is that just as spam cannot be blocked effectively by examining only the message headers and subject lines of e-mails, spyware cannot be blocked effectively by examining only the URLs. E-mails do not have to be sent and received in real time. As such, they can be held for relatively long periods of time by e-mail servers while they are scanned for spam. In contrast, a web proxy must respond to an HTTP request in a timely fashion.

2.0 Structural and Functional Overview

According to an embodiment, real-time analysis is performed on a database of network resource identifiers to detect network resource identifiers of pages or resources that contain or are associated with some form of malware. In this description, the term “network resource identifier” means a URL, uniform resource identifier (URI), or other identifier of a website, domain, application, data or other resource that is available on a network. A “resource” broadly refers to any information, service, application or system that is available using network data communications, and includes a Web site, a Web page, an HTML form, a CGI-BIN script, an online database, etc.

The approaches herein use reputation information to control requests to obtain network resources using HTTP and other web protocols. In an embodiment, a Web Reputation Score is a numeric value providing a variable rating of the likelihood that a particular network resource identifier presents a security risk for visitors, such as spyware, viruses, phishing, and potentially spam.

Reputation information may be derived from whitelists, blacklists, blocklists, and other sources and can be used to control user network access in a variety of ways. For example, information on destinations or recipients of outbound email can be used to determine whether access a domain of a network resource, such as a URL, should be allowed. For example, if a user elects to send email to a particular domain, then that domain may be scored with a higher reputation than in the absence of such outbound mail information. The source data for reputation scores may be transformed, in one embodiment, into a reputation score ranging, for example, from −10 to +10.

Web Reputation Scoring forms one component of preventive web security solutions as described herein. Web Reputation Scoring may be implemented in a stand-alone network security appliance, software solution, or network-accessible service.

In this document, Web Reputation Filtering refers to the technology that allows users to apply a Web Reputation Score to a URL, domain, IP address, or other web server identifier to protect against known and potential network security threats.

In an embodiment, a method is provided to assign to web sites a score that represents the likelihood of a security threat from that site, and a means is provided to filter and control network traffic in response to that threat.

Embodiments provide benefits including protection from web-based security threats; blocked access to known threats; customer-defined action against suspected threats; faster response time for site changes; increased performance of reactive web proxy security solutions; blacklisted and whitelisted sites can bypass more resource intensive (e.g., content) filtering.

3.0 Example Processes and Architecture

3.1 System Overview

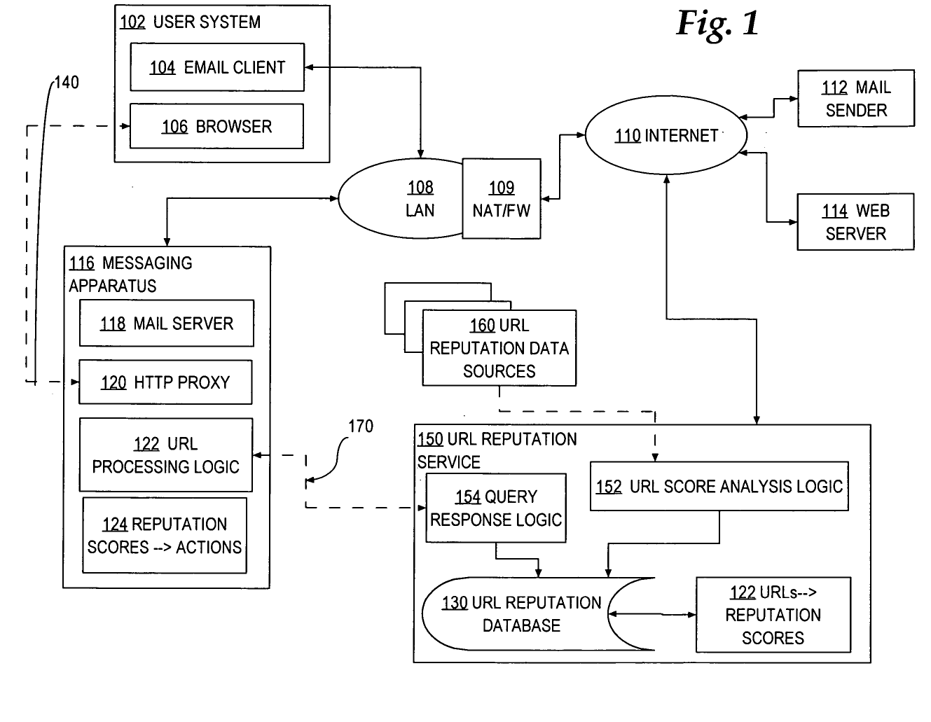

FIG. 1 is a block diagram that illustrates an overview of a system that can be used to implement an embodiment. A user system 102 hosts an e-mail client 104 and a browser 106, and is coupled to a local area network (LAN) 108. E-mail client 104 is an HTML-enabled e-mail reading and sending program, for example, Microsoft Outlook. Browser 106 can render HTML documents and communicate with network resources using HTTP. For example, browser 106 comprises Firefox, Netscape Navigator, Microsoft Internet Explorer, etc.

For purposes of illustrating a clear example, FIG. 1 illustrates LAN 108 coupled to one user system 102; however, in other embodiments any number of user systems is coupled to the LAN. LAN 108 is coupled directly or indirectly through one or more internetworks, represented by Internet 110, to a mail sender 112 and a network resource such as Web server 114.

Mail sender 112 generally represents any entity that sends e-mail messages directed to user system 102 or a user of the user system; the mail sender may be a legitimate end user, a legitimate bulk commercial mailing site, or a malicious party.

Web server 114 holds one or more network resources such as Web sites, HTML documents, HTTP applications, etc. The Web server 114 may be owned, operated, or affiliated with mail sender 112, or may be independent.

A network address translation (NAT) or firewall device 109 may be deployed at an external edge of LAN 108 to control the flow of packets to or from the LAN, but NAT/FW 109 is not required.

A messaging apparatus 116 is coupled to LAN 108 and comprises in combination a mail server 118, HTTP proxy 120, URL processing logic 122, and a URL reputation score-action mapping 124. Messaging apparatus 116 has an “always on” network connection to LAN 108 and thereby has constant connectivity to Internet 110 for communication with URL reputation service 150 at any required time, as further described. In one embodiment, mail server 118 comprises a simple mail transfer protocol (SMTP) mail transfer agent that can send e-mail messages through LAN 108 to other local users and through Internet 110 to remote users, and can receive messages from the LAN or Internet and perform message-processing functions.

HTTP proxy 120 implements HTTP and can send and receive HTTP requests and responses on behalf of user system 102 and other users systems that are coupled to LAN 108. In an embodiment, the browser 106 of user system 102 is configured to use an HTTP proxy rather than sending and receiving HTTP requests and responses directly, and is configured with a network address of HTTP proxy 120, as indicated by dashed line 130. Such configuration may be an explicit configuration, or HTTP proxy 120 may be configured as a transparent proxy. Thus, when a user of system 102 selects a hyperlink referring to Web server 114 and contained in an HTML document that browser 106 is displaying, the browser generates an HTTP request directed to HTTP proxy 120 rather than to Web server 114. Other configuration modes are described further herein. Further, HTTP proxy 120 may comprise logic to implement the functions that are described further herein.

In an embodiment, the operation of HTTP proxy 120 may be controlled using one or more access control rules in a configuration file. The access control rules enable limiting the use of a proxy in various ways. For example, limits may be imposed on usage during the business day, to authorized users, or to safe content only; controls may distribute the work among a collection of proxies. In an embodiment, HTTP proxy 120 enables an administrator to configure a set of rules that can be applied to every web transaction, to block it or alter it in some way. Further information about using access control rules appears in the priority provisional application in the section entitled “Access Control Rules.”

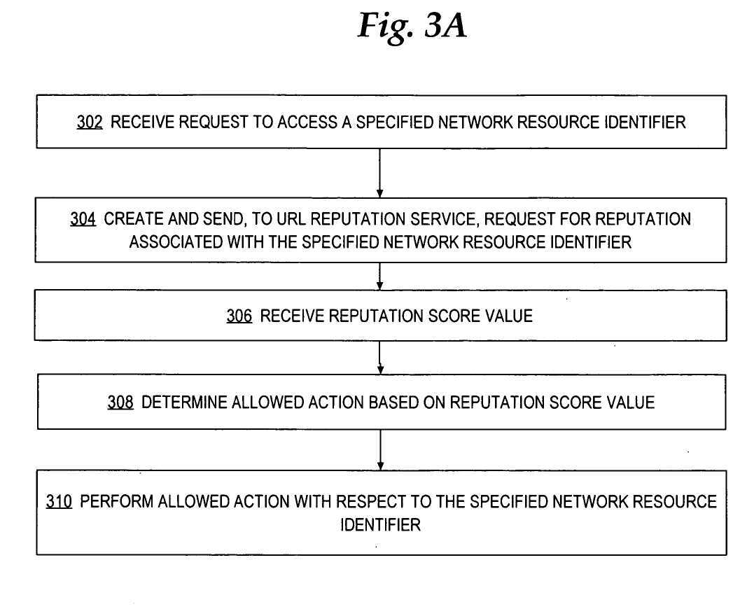

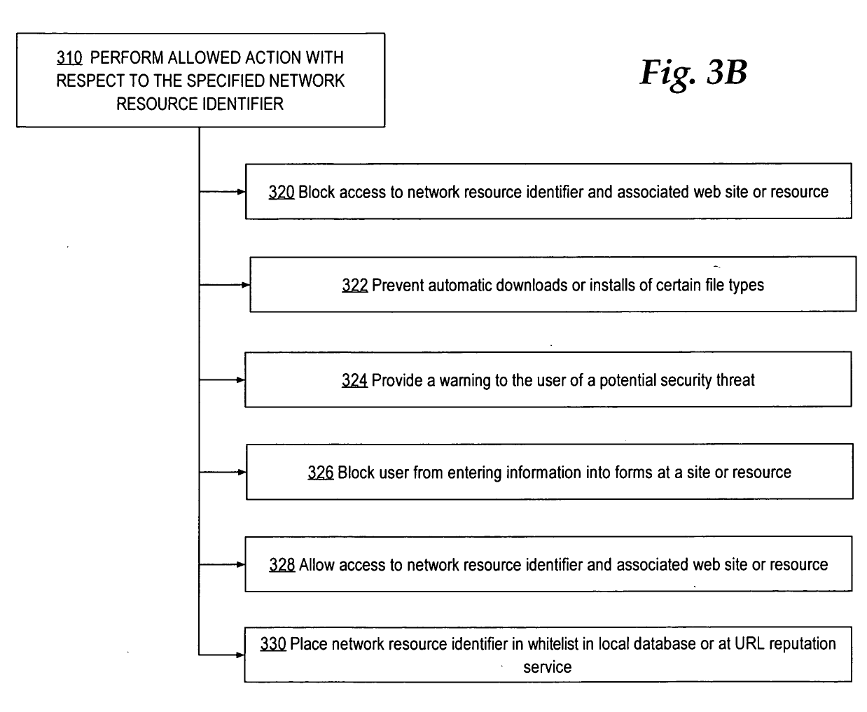

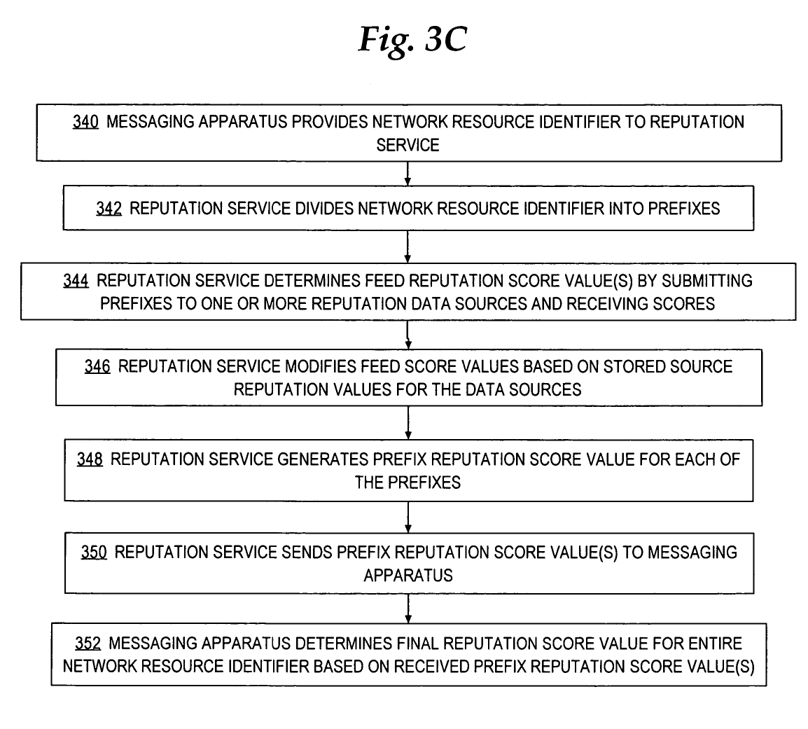

URL processing logic 122 comprises one or more computer programs, methods, processes, or other software elements that implement the functions that are described further herein, such as the functions of FIG. 3. In general, URL processing logic 122 functions to calculate a URL reputation score value or result based on locally stored prefix scores, periodically send information back to the server, and receive prefix score updates from the server. Prefix scores are described further herein. In an embodiment, URL processing logic 122 and HTTP proxy 120 may be integrated as one functional unit.

URL reputation score-action mapping 124 comprises stored data that associates URL reputation scores with responsive actions. The meaning of URL reputation scores and responsive actions is described further in other sections herein. In general, mapping 124 provides messaging apparatus 116 with information that enables the messaging apparatus to determine what actions to allow or block when a user requests access to a particular URL.

In one embodiment, messaging apparatus 116 comprises any of the IronPort Messaging Gateway Appliances that are commercially available from IronPort Systems, Inc., San Bruno, Calif., configured with application software and/or operating system software that can perform certain functions described herein.

A URL reputation service 150 is coupled to Internet 110 and comprises URL score analysis logic 152, query response logic 154, URL reputation database 130, and URL-reputation score table 122. URL reputation service 150 can receive information from a plurality of URL reputation data sources 160, which may be co-located with the URL reputation service, or located in Internet 110 or on LAN 108. In general, URL reputation service 150 functions to receive, aggregate, and prune data feeds from reputation data sources 160 and messaging apparatus 116; to maintain the URL reputation database 130 with prefix score information including calculating scores for URL prefixes and pruning entries; and updating proxies at instances of messaging apparatus 116 with prefix scores. Prefixes and their use are described further herein.

URL score analysis logic 152 comprises one or more computer programs or other software elements that perform certain functions described herein relating to receiving URL reputation data, processing the data to determine the probability that a URL is associated with malware, and creating and storing URL reputation score values. In an embodiment, URL score analysis logic 152 generates source score values for each of the data sources 160, and also receives requests from URL processing logic 122 and returns one or more prefix score values representing reputation of a set of prefixes that form components of a specified URL. The URL processing logic 122 or HTTP proxy 120 then determines a final reputation score value for the specified URL based on the prefix score values, and determines a responsive action, as further described herein.

Query response logic 154 comprises one or more computer programs or other software elements that perform certain functions described herein relating to receiving a request to provide a URL reputation score value for a particular URL, and responding with the score value. URL reputation database 130 is a data repository that comprises at least the URL-reputation score table 122, which stores URLs or portions thereof in association with reputation score values. In an embodiment, a URL or a portion of a URL is a key field in table 122. Thus, given a particular URL, database 130 can retrieve a corresponding reputation score value and return that score value in response to a request. Queries and responses may be received and sent on a logical connection 170 between URL processing logic 122, or between other logic in messaging apparatus 116, and URL reputation service 150. Logical connection 170 physically may comprise a flow of packets through LAN 108 and Internet 110.

In this context, a proxy is an intermediary program which acts as both a server and a client for the purpose of making requests on behalf of other clients. Requests are serviced internally or by passing them, with possible translation, on to other servers. A proxy may interpret and, if necessary, rewrite a request message before forwarding it. Proxies are often used as client-side portals through network firewalls and as helper applications for handling requests via protocols not implemented by the user agent.

A forward proxy is a particular proxy deployment scenario wherein the clients (browsers, media players etc) have explicitly been configured to route the traffic (HTTP, FTP etc) via the ‘forward proxy’ system. This can be set either manually or the administrators can configure this automatically via a WPAD script.

A transparent proxy is a particular proxy deployment scenario wherein no configuration is needed at the clients end. The traffic between the clients and web servers gets intercepted and diverted to the transparent proxy. The interception can be carried out in multiple ways depending on the network setup. Administrators can either place the proxy physically inline between the client and server traffic (also known as Ethernet Bridging) or could use a Layer-4 switch or a WCCP router to divert the traffic to the proxy.

Ethernet bridging is a network setup that is accomplished by plugging the proxy device (or any similar device) in the physical network topology between the clients and the router. This gives us the chance to integrate a surveying and/or regulating instance transparently into an existing network. This setup requires no changes to the logical network topology.

In various embodiments, messaging apparatus 116 may be implemented as Explicit Anti-spyware Proxy in Forward Mode; Transparent Anti-spyware Proxy in Ethernet Bridging Mode, Transparent Anti-spyware Proxy with Layer-4 switch, or Transparent Anti-spyware Proxy with WCCP v2 Router. The messaging apparatus 116 also may work with an existing proxy in another computing unit.

In deployment as an Explicit Anti-Spyware Proxy in Forward Mode, client traffic is routed to the appliance via a client side configuration, in either a PAC file or specific browser settings. The configuration on the client controls which traffic is routed to the proxy. Administrators might achieve pseudo load-balancing by dividing their end-users into multiple groups, each with a different primary/secondary proxy setting in their PAC file. A load balancer might also be deployed before the appliance to achieve true load balancing.

In a deployment as a Transparent Anti-spyware Proxy in Ethernet Bridging Mode, the appliance is deployed as an interception proxy; it physically sits between the client and the router. All Internet traffic is routed through the appliance on its way to the router. The administrator must configure the appliance explicitly to function in bridging mode, and connect the public side and private side of the network to the 2 ports on the hardware pass-through card. The pass through card must be configured to default open (becomes a wire) so the appliance will not disrupt Internet traffic flow in case of catastrophic failures. The administrator must also specify the ports for the HTTP, HTTPS and FTP proxy on which the proxy listens on. This deployment mode has the benefit that there are no client side configuration requirements (either in the browser or via a PAC file) or additional hardware (Layer 4 switch or WCCP router) required. This is the only mode in which all traffic passes through the appliance without any external settings.

In deployment as a Transparent Anti-spyware Proxy with Layer-4 switch, the administrator has to configure a Layer-4 switch (such as ServerIron) to redirect the traffic between the client and the web servers to the proxy. The Layer-4 switch maintains the necessary states to redirect all the outbound requests and the inbound responses for the specified protocols. The administrator must configure the appliance explicitly to function with a layer-4 switch.

In deployment as a Transparent Anti-spyware Proxy with WCCP v2 Router, the administrator has to configure the WCCP Router to redirect the traffic between the client and the web servers to the proxy. The router maintains the necessary state information to redirect all the outbound requests and the inbound responses for the specified protocols.

Deployments with an existing proxy solution such as BlueCoat, NetApp, or DataReactor are also possible.

3.2 Determining URL Reputation Values

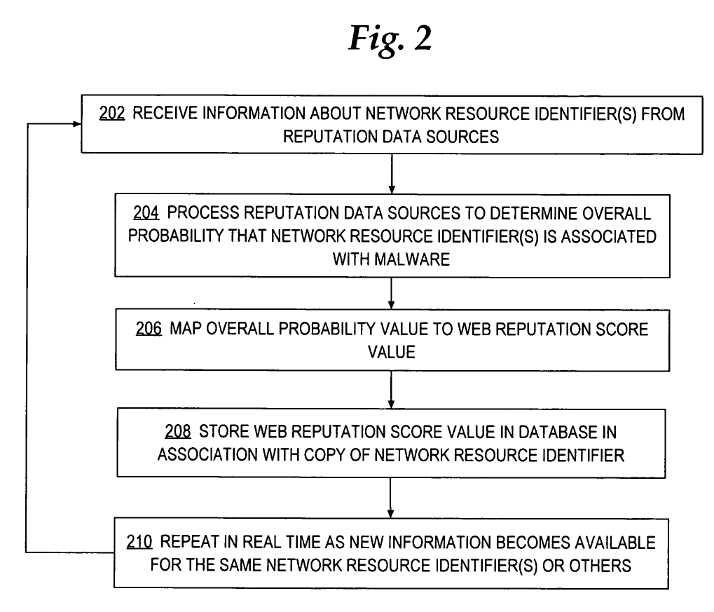

FIG. 2 is a flow diagram that illustrates a high level overview of one embodiment of a method for determining URL reputation values. The functions of FIG. 2 may be performed, for example, by cooperation between URL score analysis logic 152 and URL processing logic 122 of one or more instances of messaging apparatus 116.

FIG. 2 generally provides a process in which information about URLs can be received from any of a variety of sources, processed to determine a reputation score value for the URL, and stored in a repository for later use. Spam, URL-based viruses, phishing attacks, and spyware all direct the user to a malicious URL. Analyzing these URLs and associating a reputation score value with them enables stopping attacks more quickly and accurately, and enables avoiding the URL regardless of how the URL is disseminated to users. Thus, the reputation score values that are created and stored using the approach of FIG. 2 are developed using machine steps that address a simple but powerful question: “What is the reputation of the URL?”

In step 202, information about one or more network resource identifiers is received from reputation data sources. For example, URL reputation service 150 receives information about a particular URL from one or more URL reputation data sources 160. The received information may come from any of a plurality of sources. Examples include information indicating how long the domain in a URL has been registered, what country the website is hosted in, whether the domain is owned by a Fortune 500 company, whether the Web server is using a dynamic IP address, etc.

In one embodiment, a broad set of parameters from the SenderBase® service of IronPort Systems, Inc. is received. The parameters can be used as indicators about a reputation of a URL. Example parameters include: URL categorization data; the presence of downloadable code at a web site; the presence of long, obfuscated End User License Agreements (EULAs); global traffic volume and changes in volume; network owner information; history of a URL; age of a URL; the presence of a URL on a blacklist of sites that provide viruses, spam, spyware, phishing, or pharming; the presence of a URL on a whitelist of sites that provide viruses, spam, spyware, phishing, or pharming; whether the URL is a typographical corruption of a popular domain name; domain registrar information; IP address information. Additionally or alternatively, step 202 can involve receiving blacklists, whitelists, or other information sources from other third parties that list URLs or network resource identifiers. External reputation data sources that have a subset of data, or a functionally equivalent set of the data in the IronPort SenderBase service may be used.

As other examples, a user community can report web security threats. An example user community is the SpamCop reporter community. In an embodiment, a browser plug-in enables users to report a site that is suspected of distributing spyware, viruses, phishing attacks, or spam. In an embodiment, domain names of any URLs found in spamtrap messages are used in determining reputation.

In an embodiment, a URL domain name may be scored by association of the SMTP reputations of connecting IP addresses associated with that same domain. The SMTP domain that is used generally should be difficult to forge. Possibilities include rDNS domain as used in IronPort SenderBase or domains authenticated via protocols such as Domain Keys or Sender ID.

In an embodiment, methods to determine ownership relationships between different domains are provided, to prevent rogue operators from simply purchasing many different domain names and moving between them in order to avoid being saddled with a poor reputation. Methods may include elements as matching mailing address of WHOIS entries or mapping proximity of physical registration addresses.

In an embodiment, a component of a site's score is based in part on the links to and from that site. A site that posts a link to others sites with low web reputations is given a lower score because of that link. Posting a link is an implied recommendation of that site, and may be treated as such in the Web Reputation Score. Similarly, links to high reputation sites may boost a reputation. In an embodiment, the linking works both ways so that a site with a good reputation linking to a given site is a positive indicator for that given site.

In an embodiment, information about the machines that are used to host a site can be used in determining reputation of a URL. Machine information may include geographic information about where the server is located, the identity of the web proxy provider (perhaps targeting providers with poor Acceptable Use Policies), the identity of a web hosting provider (perhaps targeting providers with poor Acceptable Use Policies), and whether forward and reverse DNS records resolve (or what fraction resolve).

In an embodiment, examining traffic for suspicious patterns may be performed. For instance, significant repeated activity to a URL during non-business hours may be indicative of a spyware program “phoning-home” data. The age of a domain or web server may be a determining factor. Very new sites may be treated with caution, since these will certainly be strong indicators for certain threats, particularly phishing. Age may be measured both by the time elapsed since the first web traffic has been seen to the site and the length of time since the domain was registered or changed ownership.

In an embodiment, a web crawler searches for and records sites providing malicious code or doing heuristic analysis of site content. A web crawler is most useful for finding new sites serving viruses and spyware. Certain classes of sites that may be more important to search, such as URLs that appear in spam messages.

Further, in an embodiment, data received at the URL reputation service 150 from deployed instances of messaging apparatus 116 is provided as input to the crawler, which is treated as a data feed equivalent to one of the reputation data sources 160 and enables the server to calculate prefix scores. In an embodiment, periodically, a proxy sends a log of all URLs that were visited in that time period along with any information available about a given URL, including number of hits; reputation score value result; ASW request-side verdict; and ASW response scan result. The URL reputation service 150 may implement its own ASW engines, which may be the same ASW engine deployed on the messaging apparatus 116 and others. In this approach, even if the HTTP proxy of a messaging apparatus 116 returns ASW results for a URL, ASW scanning by the URL reputation service 150 may yield more conclusive results (by scanning with multiple ASW engines).

In an embodiment, the URL reputation service 150 scans the same URL that the client visited, minus any query strings, parameters, user names, and passwords, which the HTTP proxy strips from the URL before sending the URL to the server.

In an embodiment, IP address space information is also considered and URL reputation service 150 creates reputation inferences from IP address space assignments. For example, a non-profit organization is less likely than a service provider to host spyware; an IP address block of dynamically assigned IP addresses should be more negatively scored than static IP addresses (since dynamic IP addresses should never be hosting URLs); and other inferences may be made. Sources of IP address space information include ICANN, domain registrars such as Verisign, and anti-spam or anti-spyware web sites such as TQMCUBE. As an example result, if an IP address is dynamic, then a score of −10 is determined, since no client should be requesting a URL from a dynamic IP address. If the address is static, then a “category score” for the IP address is generated, based the malware risk represented by the address block owner's functional category (e.g. retail, porn, education, etc.). The FutureSoft categorization database could be used for this.

The fact that a machine is an open HTTP proxy may factor into Web Reputation Score. This may not be an input to the score itself, but an option for an administrator to block access to open proxies. If end users have the ability to use open proxies, these may be used as a means to access sites with security threats. However, there may be legitimate reasons that users need to access open proxies, and such information may be obtained through 3^{rd} party lists or generated at a service provider that implements the system.

Different content types are more likely to pose a security risk than others. For example, sites with gambling or pornographic content have historically been more likely to host spyware than other content types. In addition, it is possible that sites providing free services are more likely to be security threats that ones based on subscription fees. Content type information associated with a site may be considered in determining a reputation score value for a URL.

Web honeypot data, obtained from unprotected machines exposed to the Internet to try to determine sources of attacks, can be used to determine reputation score values. For instance, machines found to be port scanning may be treated as greater risks for security threats.

Thus, no particular minimum size of data sources is contemplated. Better results can be expected with embodiments that use a large volume of data, coming from diverse data sources, with breadth and high quality. In an embodiment, URL reputation data sources 160 comprise a database that receives data from ISPs, large enterprises, and other sources. One or more Web crawler programs can be used to locate newly created or modified URLs. The URL reputation data sources 160 can comprise third party blacklists, whitelists or other sources that reliably identify URLs that are associated with viruses, spam, spyware, phishing, and pharming.

In step 204, the reputation data sources are processed to determine the overall probability that the one or more network resource identifiers are associated with malware of any kind. For example, URL score analysis logic 152 processes a particular URL, information received at step 202, and the parameters identified above to result in creating an overall probability value, which is temporarily stored.

Values received from data sources may be assigned an initial feed score that is then modified to produce a combined reputation final score value for a network resource identifier. The initial feed score for a data source may vary according to a perceived reputation of the source. For example, feed scores for domains and/or IP addresses in whitelists and blacklists may be assigned based on the perceived reputation of the list author and the perceived accuracy of the list itself. For example, domains from a TRUSTe whitelist could be assigned feed scores of +6 because of the ability to compile an accurate list. Domains from the MVPS blacklist could be assigned feed scores of −6 for the same reason. Domains from the SURBL blacklist could be assigned feed scores of −3 based on a lower belief in SURBL's ability to blacklist spyware URLs than in the MVPS list's ability, as SURBL is more focused on e-mail related URLs rather than spyware-related URLs.

In one embodiment, in step 204 each of the data sources and parameters identified above is repeatedly tested to determine the probability that URLs associated with a particular parameter contain malware. A corresponding weight is assigned to each of the parameters. For example, a high weight may be given to a parameter indicating the presence of URLs on a trusted blacklist, because that parameter is strongly associated with URLs that have malware. As another example, network owner information from the “whois” database cannot be given a high weight because that database is essentially neutral with respect to reputation; it contains owner information for URLs with malware as well as many URLs that are harmless or even beneficial.

The use of multiple parameters helps improve the quality and reliability of results. For example, one parameter may be the number of requests for a particular URL—that is, traffic volume. A sudden spike in traffic may correlate well with a new virus outbreak that is using a URL to deliver the payload; however, there are legitimate instances of traffic spikes, such as publication of breaking news by a reputable news website. Thus, if a traffic spike alone is used as a metric, many legitimate URLs might be blocked. However, when a traffic spike is examined in addition to other parameters, such as URL age, presence on URL whitelists, and an IP address that is known to be in the range allocated to a Fortune 500 company, a much more accurate conclusion can be made.

Further, in step 204 a particular URL is received and then evaluated against all the parameters to determine the overall probability that the particular URL contains malware. Step 204 may comprise receiving a URL, contacting the reputation service 150 to request a score value for each of several prefixes associated with the URL, and combining the prefix score values to result in a final score value for the URL. The use of prefixes is described further herein. In brief, for prefixes for domain-based URLs may include a Domain, Subdomain(s), Path segment(s), and Port. For prefixes for IP-based URLs may include an IP address and subnet mask, Path segment(s), and Port.

For example, if the particular URL indicates a web site that has downloadable code, but the age of the URL is known to be old and the URL is on a whitelist, then the overall probability value may be low. In contrast, if the particular URL indicates a web site that has downloadable code, but the age of the URL is known to be old and the URL is on a blacklist, then the overall probability value may be moderately high. If the particular URL is on a blacklist, has downloadable code, is known to have a long, obfuscated EULA, and is a typographical corruption of a popular domain name, then the overall probability value may be very high.

In step 206, the overall probability value is mapped to a URL reputation score value. In one embodiment, URL score analysis logic 152 maps the overall probability value of step 204 to a score ranging from (−10) to (+10), in which a URL with a URL reputation score of (−10) is most likely to contain malware and a URL with a URL reputation score of (+10) is least likely to contain malware. In other embodiments, any range of numeric values, alphabetic values, alphanumeric values, or other characters or symbols may be used. Table 1 provides examples of URL reputation scores that may be associated with particular characteristics of URLs.

TABLE 1
EXAMPLE URL REPUTATION SCORES

| | |
|---|---|
| (−9) | URL downloads information without user permission, and is on |
| | multiple blacklists. |
| (−7) | IronPort SenderBase shows a sudden spike in volume of |
| | requests to URL, and URL is a typographical corruption of a |
| | popular domain |
| (−3) | URL is recently created and uses a dynamic IP address and |
| | downloadable content |
| (+3) | Network owner IP address has positive IronPort SenderBase |
| | Reputation Score |
| (+6) | URL is present on several whitelists, has no links to other |
| | URLs with poor reputations |
| (+9) | URL has no downloadable content, has a domain with a long |
| | history and consistently high and stable volume |

In step 208, the URL reputation score value is stored in a database in association with a copy of a network resource identifier that has the associated score. In one embodiment, URL score analysis logic 152 stores the complete URL in URL-reputation score table 122 of URL reputation database 130. In another embodiment, the stored network resource identifier is a portion of a URL, such as a domain name. In another embodiment, the stored network resource identifier is a regular expression that includes a portion of a URL, e.g., “www.this-site.com/products/*”.

In step 210, the process repeats steps 202-208 in real time as new information becomes available for the same network resource identifiers or for other network resource identifiers.

The URL reputation score values that are developed with the process of FIG. 2 are highly granular and enable a network device to perform a variety of different actions for a particular URL. Thus, the approach herein contrasts with past approaches that are based only on blacklists or whitelists and permit only a binary “good/bad” decision about malware. The highly granular score offers administrators increased flexibility, because different security policies can be implemented based on different URL reputation scoring ranges.

3.3 Controlling Access Based on Reputation

FIG. 3A is a flow diagram that illustrates a high level overview of one embodiment of a method for controlling access to network resources based on reputation; FIG. 3B is a flow diagram that illustrates example control actions. For purposes of illustrating a clear example, FIG. 3A and FIG. 3B are described herein in the context of FIG. 1. However, the approach of FIG. 3A and FIG. 3B can be practiced in many other contexts.

Referring first to FIG. 3A, in step 302, a request to access a specified network identifier is received. For example, a user of user system 102 enters a URL in browser 106, which creates an HTTP request for the URL and sends the request. HTTP proxy 120 intercepts the request, using link 140, and invokes URL processing logic 122.

In step 304, a request for the URL reputation score value associated with the specified network identifier is created and sent. For example, URL processing logic 122 creates and sends a request on logical connection 170 to URL reputation service 150. In response, the query response logic 154 extracts the specified network identifier and issues a retrieval request to URL reputation database 130. If the specified network identifier is indexed in URL-reputation table 122, then the query response logic 154 receives a corresponding URL reputation score value and provides the value in a response to URL processing logic 122. At step 306, a reputation score value is received, for example, at URL processing logic 122.

In an embodiment, steps 304-306 involve determining a reputation score value at URL processing logic 122 based upon receiving one or more separate prefix score values from the reputation service 150. FIG. 3C illustrates an example process of determining a reputation score value. At step 340, the messaging apparatus provides a network resource identifier to the reputation service. For example, URL processing logic 122 provides a URL to the reputation service 150.

In step 342, the reputation service separates the network resource identifier or URL into one or more prefixes. In step 344, the reputation service determines a feed reputation score value for each of the prefixes based on submitting the prefixes (or the entire network resource identifier or URL) to the data sources 160 and receiving results (“feeds”) from the data sources, or based on stored information from data sources 160.

In step 346, the reputation service modifies or weights the feed reputation score values based on source reputation values for the data sources, resulting in generating a prefix reputation score value for each of the prefixes at step 348. Optionally, the reputation service stores the prefix reputation score values in URL reputation database 130. In step 350, the reputation service returns the prefix reputation value(s) to the messaging apparatus. In step 352, the messaging apparatus determines a final reputation score value for the entire URL based on the prefix reputation value(s). The prefix reputation score values may be weighted and combined in ways described further herein.

Referring again to FIG. 3A, in step 308, an allowed action is determined based on the reputation score value. For example, URL processing logic 122 retrieves one or more allowed action values from reputation score-actions table 124, using the received URL reputation score value as a key. Thus, step 308 enables the messaging apparatus 116 to determine what actions a user is allowed to perform for the specified network identifier, based on its reputation as derived from many external data sources.

In step 310, the allowed action is performed with respect to the specified network identifier. Various embodiments involve performing a variety of allowed actions. Referring now to FIG. 3B, examples of responsive actions that may be performed based on different URL reputation score values are shown. For example, messaging apparatus 116 may block access to the network resource identifier and any associated web site or resource, as shown in block 320. Messaging apparatus 116 may prevent automatic downloads or installations of certain file types, as shown in block 322. For example, downloads or installations of EXE or ZIP files can be blocked. Messaging apparatus 116 may provide a warning to a user of user system 102 that a potential security threat exists for the network resource identifier, as shown in block 324.

Messaging apparatus 116 may block the user from entering information into HTML forms provided at a site or resource, as shown in block 326. Messaging apparatus 116 may allow access to the network resource identifier and any associated web site or resource, as shown in block 328. Messaging apparatus 116 may place the network resource identifier in a whitelist that is maintained in a local database or at the URL reputation service 150, as shown in block 330.

Embodiments may be applied in a variety of practical scenarios. As a first example, the approach herein can be used to block spam email messages that contain URLs associated with advertising websites. Traditional anti-spam solutions evaluate whether an email is spam by examining the nature of the content of the message. However, spam senders have found many techniques to circumvent content analysis techniques, such as adding blocks of legitimate text to a message, or using numbers instead of letters (e.g., “L0ve”). As a result, content analysis tools have lost effectiveness, but examining the reputation of URLs carried in email messages can enable messaging apparatus 116 to determine whether to block delivery of the email messages.

For example, in one embodiment, when mail server 118 receives a new inbound message directed to user system 102, the mail server extracts each URL contained in the message and provides the URLs to URL processing logic 122, which determines a URL reputation score value for the URL using URL reputation service 150 and an allowed action from table 124. The allowed action may indicate delivering the message, placing the message in quarantine, blocking delivery of the message, generating and sending a notification, stripping the URLs from the message and then delivering it, etc.

Another use scenario for the approaches herein can dramatically improve resistance of user system 102 to spyware. Typical spyware solutions contain relatively static blacklists and spyware signatures. When new spyware is deployed at a website, with typical solutions the spyware objects must be deconstructed and signatures must be prepared, a process that can take days, during which user system 102 is not protected against attack.

With the present approach, URL reputation service 150 continually evaluates URLs for the presence of spyware and places a record in URL reputation database 130 with an updated URL reputation value as soon as a URL is determined to deliver or have an association with spyware. When user system 102 attempts to access a URL with a recently updated, low URL reputation score value, access can be blocked. Thus, the reaction time gap between deployment of spyware and creating an effective defense for user system 102 is reduced significantly.

Still another use scenario for the approaches herein is to determine what additional scanning operations should be performed for a message. Many other examples and scenarios are provided in the attached documents.

3.4 Example System Architecture Details

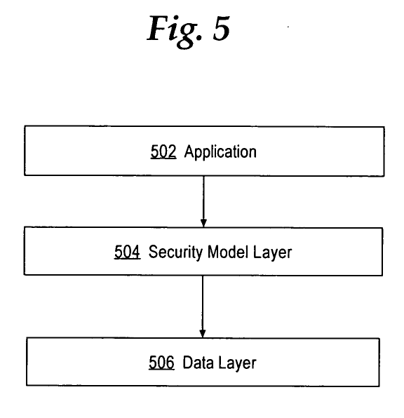

FIG. 5 is a block diagram of a logical organization of a system for controlling access to network resources based on reputation.

Data layer 506 obtains data from a plurality of sources that tend to indicate something about the reputation of a network resource. Example data sources include whitelists, blacklists, block lists, DNS information, “whois” information, URL block lists such as SURBL, Web ratings services, information indicating which Web site category a user has assigned to a Web site using Microsoft Windows Internet Explorer's security settings, etc. Each data source may have a separate reputation scores associated with it that indicates the reliability or trustworthiness of the data source. Data source reputation scores may be manually assigned by an administrator, or could be automatically adjusted, for example, when a data source changes from an expected profile with respect to message volume or sender volume.

Security model layer 504 comprises one or more software elements or hardware elements to cooperate to compute Web reputation scores based on the data sources. In an embodiment, security model layer 504 may compute a plurality of different Web reputation scores. For example, different scores can indicate the likelihood that a particular network resource is associated with spam, phishing attacks, pharming attacks, etc.

Application layer 502 comprises one or more applications that use a Web reputation score for various purposes. Example purposes include security functions, such as blocking access to URLs that have a poor reputation.

According to an embodiment, one or more data sources 602 are coupled to a web reputation server 604. The web reputation server 604 is coupled through a network 606 to a messaging gateway 608, which is coupled to a local network 610. The messaging gateway 608 receives one or more requests, from one or more clients 612, to access resources 614 that are coupled to network 606. Resources 614 may include Web sites, databases, content servers, or any other information that is accessible using a network resource identifier such as a URL. Requests may include HTTP requests, HTTPS requests, FTP requests, or requests presented using any other networking protocol.

In an embodiment, messaging gateway 608 comprises a proxy 620, web reputation logic 622, database 624, content processing logic 626, and traffic monitor 628. Proxy 620 is configured either as an explicit HTTP proxy or transparent HTTP proxy with respect to clients 612. In this configuration, proxy 620 intercepts any HTTP request issued by clients 612 and any HTTP response from resources 614 relating to such a request. Proxy 620 then provides requests and responses to web reputation logic 622 for further evaluation. If one of the clients 612 issues an HTTPS request, then proxy 620 performs SSL/TLS termination within gateway 608 on behalf of the clients.

In an embodiment, content processing logic 626 comprises one or more verdict engines 630, 632, 634, the functions of which are further described herein.

HTTP requests from clients 612 on protocol port 80 are coupled to web reputation logic 622. Requests in all other protocols from clients 612 are coupled to traffic monitor 628. In an embodiment, traffic monitor 628 receives all Layer 4 requests other than HTTP requests. Accordingly, messaging gateway 608 can intercept and examine all requests of clients 612 for information on any open firewall ports other than port 80.

For HTTP requests, web reputation logic 622 determines a reputation value associated with a network resource referenced in the request. Based on the reputation value and locally configured policy, web reputation logic 622 determines whether to permit clients 612 to access the requested resource. Traffic monitor 628 determines a reputation value associated with a network resource referenced in requests on any port other than port 80. Traffic monitor 628 determine whether clients 612 should access the requested resource based on the reputation value and local policy.

In an embodiment, web reputation logic 622 and/or traffic monitor 628 perform web content filtering. Web content filtering comprises receiving an HTML document from a network resource and determining whether a requesting client is permitted to view the HTML document based on keywords, HTML elements, or image content of the document. In an embodiment, web reputation logic 622 and/or traffic monitor 628 perform compliance filtering.

Web reputation logic 622 uses data to determine what network resources to further scan using content processing logic 626. For example, a web reputation score for a particular network resource may comprise an integer value in the range −10 to +10. Web reputation logic 622 determines whether to perform further scanning with content processing logic 626 based on the magnitude of the web reputation value. Fixed logic or configurable policy may determine what action is taken for a particular web reputation value.

As an example, if the web reputation score for a particular network resource is −10 to −7, then web reputation logic 622 drops the client request to access that resource, thereby blocking user access to a potentially harmful network resource based on its reputation. If the score is −7 to +5, then web reputation logic 622 requests content processing logic 626 to perform further scanning on the resource. For example, web reputation logic 622 issues an API function call to content processing logic 626 and provides an identifier of a network resource or client request. If the score is +5 to +10, then web reputation logic 622 permits the client to access the resource without further scanning. Any other ranges of values and responsive actions may be used.

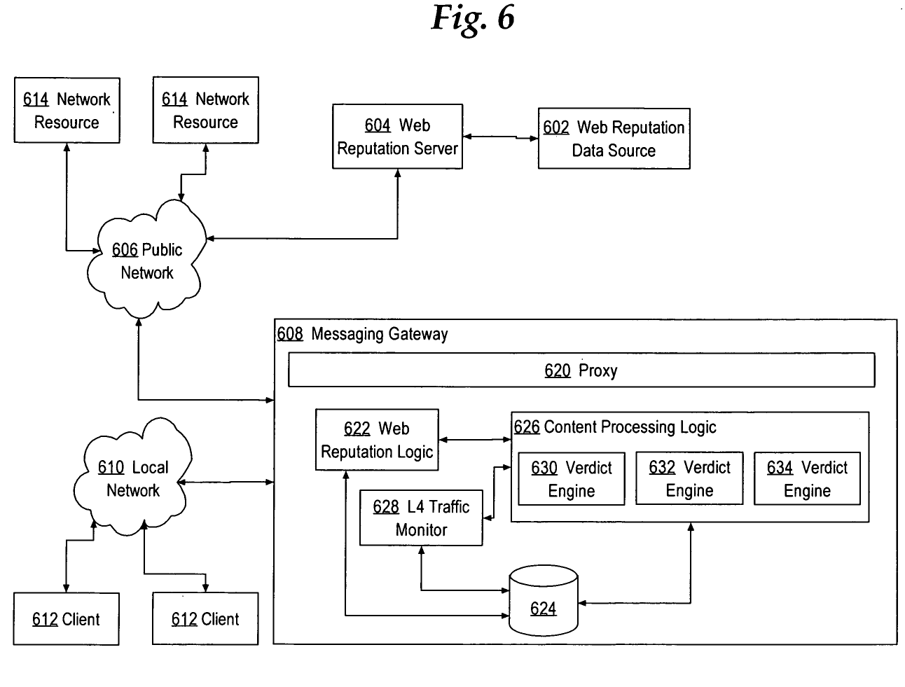

Upon receiving a request from web reputation logic 622 to scan a potentially harmful network resource, content processing logic 626 invokes one or more of the verdict engines 630, 632, 634 to actually scan content of the network resource and determine whether the network resource appears potentially harmful. In an embodiment, content processing logic 626 comprises Context Adaptive Scanning Engine™ technology from IronPort Systems, Inc., San Bruno, Calif. In an embodiment, verdict engines 630, 632, 634 scan network resources for different sets of signature. The architecture of FIG. 6 thus allows an HTTP gateway or messaging gateway to host multiple different scanning processes, each adapted for evaluating a different particular kind of threat associated with a network resource. To illustrate a clear example, FIG. 6 shows three (3) verdict engines, but in other embodiments there may be any number of verdict engines.

Scans performed by verdict engines 630, 632, 634 may scan a URL, an HTTP response, a hash of an HTTP response, or other information relating to requests for network resources or responses from network resources. In an embodiment, content processing logic 626 receives a request from web reputation logic 622 or a response from a network resource, parses the request or response into different content chunks, and provides different content chunks to different ones of the verdict engines 630, 632, 634.

In an embodiment, content processing logic 626 is configured to invoke particular verdict engines 630, 632, 634 for particular kinds of requests and responses. Alternatively, a user or administrator can specify, using configuration information provided to and stored in messaging gateway 608, whether a particular request or response is fed to one verdict engine or multiple verdict engines, the identity of the verdict engines and the sequence of using the verdict engines. Content processing logic 626 and the verdict engines operate on requests and responses in real time as the requests and responses flow through the messaging gateway 608.

Verdict engines 630, 632, 634 may implement a stream scanner to scan streaming content or long HTTP responses. For example, when a response comprises a large ZIP file, a verdict engine 630 can implement streaming logic to send KEEPALIVE messages to a host resource 614, so that the resource continues to send content while the verdict engine is scanning previously received content. The user continues to receive downloaded file content as the stream scan is performed. This approach prevents re-transmissions, connection or session teardowns, or other interruptions in delay-sensitive streaming content.

In an embodiment, database 624 comprises a verdict cache that stores results of previous scan operations of the verdict engines 630, 632, 634 on network resources. As an operational example, assume that content processing logic 626 receives a request from web reputation logic 622 to scan a particular URL. The content processing logic 626 searches the verdict cache in database 624 for the URL. If the URL is not found in the cache, then the URL is scanned using one or more of the verdict engines 630, 632, 634. If the scans yield a reputation score that is below a configured threshold, then the reputation score and the verdict engine results are stored in a new record in the verdict cache in association with the URL. Typically, a low reputation score will cause messaging gateway 608 to refuse access to the network resource. Further, the next time that any of the clients 612 request the same resource, the lookup operation in the verdict cache will yield a cache hit, precluding the need to re-scan the resource.

Thus, the use of a verdict cache improves efficiency by enabling verdict engines 630, 632, 634 to retrieve cached verdict results for repeatedly requested network resources 614. Although the Web reputation of a particular network resource may change over time, most changes do not occur rapidly, and therefore a caching approach can improve processing efficiency without compromising accuracy.

Embodiments may implement an exemption list comprising a list of IPs, CIDRs, and/or ports that are treated specially by the traffic monitor and the HTTP proxy if the messaging gateway has been configured as a transparent inline bridge. If the traffic matches one of the IPs, CIDRs, or ports, the traffic monitor and/or the proxy will bridge the traffic, essentially exempting it from any processing (including logging, monitoring, reporting, blocking). The list may contain source IP addresses; source CIDR blocks; destination IP addresses; destination IP blocks; and destination port values or port ranges.

In an embodiment, a messaging gateway 608 that implements verdict engines as shown herein periodically returns verdict data to the URL reputation service 150 (FIG. 1). The verdicts, both positive and negative, can be used as an input into scoring and the database or corpus. For example, assume that a messaging gateway 608 returns 100 URLs, and 10 of these URLs were determined to have spyware on them by the anti-spyware engines in the messaging gateway. In response, the URLs can be added to the corpus as spyware. They can be used to create a blacklist rule into reputation scoring to negatively influence the score of any URL that has been reported as “bad”. Similarly, the remaining 90 URLs that did not have spyware can be added to the corpus as non-spyware and can positively influence the score of any URL that has been reported as “good”.

In an embodiment, a subset of the URLs processed in the manner herein is sent to the URL reputation service 150. For example, the most popular URLs or domains are on the list. The messaging gateway can return volume statistics on URLs that it processes, so that reputation data covering the highest percentage of queries will be created. For example, assume that a messaging gateway with data returned from all sources indicates that the highest number of requested URLs is www.google.com, at 2% of all requested pages. The second highest is www.yahoo.com at 1% of all requested pages. When the system publishes a new URL list, both www.google.com and www.yahoo.com will be on this list because they will cover the most amount of traffic.

In an embodiment, messaging gateway 608 may process URLs for which the reputation service 150 has no score, (except a prefix score, only a “com” score, for example). In one embodiment, messaging gateway is configured to identify the score of URLs and to what level they have been scored (i.e., is there a specific score for the domain and the paths, or just the domain). This approach assists reputation service 150 to identify if it has adequate scoring for a particular URL, and develop a score for this URL if it does not have such information.

In an embodiment, messaging gateway 608 helps judge the efficacy of reputation service 150 relative to anti-spyware engines in the messaging gateway. In this approach, for each requested URL, logic in messaging gateway 608 returns, to the reputation service 150, the anti-spyware verdict and reputation score value as determined by the reputation service. In this way, the results can be compared to one another to determine accuracy and improve the WBRS scoring system.

Traffic monitor 628 comprises a Layer 4 protocol traffic monitor that can process requests for access to IP addresses, URLs, or domains that are associated with Layer 4 protocol ports other than HTTP port 80. For example, assume that a client 612 issues a request “5553:X.Y.Z.A”, that is, a request on port 5553 to access IP address X.Y.Z.A. Traffic monitor 628 can determine a reputation score associated with the specified IP address, and can block access to the specified IP address when the address has a poor reputation, regardless of which port number is used in the client request. Because many viruses and other malware initiate client requests using unusual port numbers to evade blockage by conventional client-based software, the approach herein enables messaging gateway 608 to prevent clients 612 from inadvertently accessing harmful content under such unusual port numbers by ignoring the port numbers and focusing on the reputation of the referenced IP address.

Certain viruses and malware attempt to initiate communications from an infected client to a malicious server or other network resource (the viruses or malware attempt to “phone home”). In an embodiment, such attempts are thwarted by intercepting, at traffic monitor 628, all DNS requests from the client 612 to resolve domains into IP addresses. The traffic monitor 628 allows the DNS request to complete by forwarding the DNS request to a DNS server. When a DNS response is received, traffic monitor 628 locally caches the resolved IP address contained in the response. Thereafter, when viruses or malware on client 612 attempt to send packets to the resolved IP address, traffic monitor 628 intercepts the packets and can compare the cached IP address to database 624 to determine if the address has a good reputation. If not, access can be blocked.

As an optimization, database 624 may store related URL objects generally contiguously to reduce the time required to transfer verdict cache information to traffic monitor 628 or content processing logic 626.

In an embodiment, a system comprises the elements and processes shown at pp. 23-27 of the priority provisional application, or the elements and processes described in application Ser. No. 11/742,015, filed Apr. 30, 2007, or application Ser. No. 11/742,080, filed Apr. 30, 2007, the entire contents of which are hereby incorporated by reference for all purposes as if fully set forth herein.

In an embodiment, messaging gateway 608 comprises logic that can generate a graphical user interface for display using a browser of a client computer that is connected over a network to an HTTP server in the messaging gateway. In an embodiment, the graphical user interface may comprise the screens, display elements, buttons and other widgets shown in pp. 28-160 of the priority provisional application. The messaging gateway 608 also may comprise logic that implements the functional operations and processing steps indicated by the screen displays shown in pp. 28-160 of the priority provisional application.

In an embodiment, reputation service 150 stores information about URLs in the form of prefixes. Prefixes describe the requested URL from left to right in such a way that subsequent URLs can be matched against them to obtain useful scoring information. A URL is transformed into a matchable prefix form by reordering the elements of the URL. In an embodiment, domain-based prefixes and IP-based prefixes are used. Domain-based prefixes enable reputation service 150 to use whitelists and blacklists that specify domains rather than IP addresses. Domain-based prefixes have the following hierarchy: Domain; Subdomain(s); Path segment(s); Port. IP-based prefixes are used because the proxy always has an IP address for a given request, whereas it does not always have a hostname (and thus, a domain to match against a domain-based prefix). These prefixes have the following hierarchy: IP address and subnet mask; Path segment(s); Port.

In an embodiment, the URL reputation score value that is determined as a final result at the messaging gateway 608 or messaging apparatus 116 (FIG. 1) is the prefix score of the entry with the longest prefix match. For example, assume that a messaging gateway 608 sends a query to the reputation service 150 for two prefixes:

ip=1.2.3.4/32, path=“foo/bar.html”, port=80

domain=“domain.com.sub”, path=“foo/bar.html”, port=80

The reputation service 150 matches the query to these records:
1. ip=1.2.3.0/24 path=“ ”, prefix_score=6.2, domain=“domain.com”
2. ip=1.2.3.0/24 path=“foo/”, prefix_score=7.1, domain=“domain.com”
p=1.2.3.4/32 path=“ ”, prefix_score=7.2 domain=“sub.domain.com”
4. domain=“domain.com”, prefix_score=6.9

Therefore, since record 2 has the longest prefix, the score returned is 7.1.

In an embodiment, messaging gateway 608 also implements a proxy for file transfer protocol (FTP) requests of clients. An FTP session uses two TCP connections between the client and server: the Command connection, and the Data connection. The FTP session is initiated by the client connecting to the server, establishing the Command connection. The Command connection is used to navigate the server's directory structure, to request a download, and for other administrative functions. The Data connection is established when a file download is to begin. Only the contents of downloaded files travel through the Data connection.

FTP has two modes: Active and Passive. They differ by how the Data connection is formed. Most (or all) modern browsers use Passive mode by default. Passive mode is requested by the client, thus: Active is the default mode; All FTP servers support Active; and Some FTP servers do not support Passive.

In Active mode: The client sends its IP address and a port number to the server (the PORT command). The server then connects to the client (the client is listening on the above address and port). In Passive mode: The client requests Passive mode (the PASV command). The server (assuming is supports Passive mode), sends its IP address and a port number to the client (the response to the PASV command). The client then connects to the server.

In Active mode, the client listens on a port and publishes that port to the server. Although the client may choose any port, older or less-secure clients will always choose port 20. This opens the client up to DOS attacks and security issues. Listening on port 20 should be completely avoided. If Active mode is ever used, a high-numbered random port should be chosen.

When deploying a content-filtering FTP-proxy, various issues exist depending on both the proxy's deployment configuration, and the FTP mode (Active or Passive). Three deployment modes may be considered: Forward, Bridged, and L4. In “Forward” mode, the browser is configured to use the proxy. In “Bridged” mode, the proxy is placed as a “next hop,” so all Ethernet traffic flows through the proxy. The browser has no proxy settings. In “L4” switch mode, a Layer-4 (L4) switch is placed as a “next hop.” The L4 switch is configured to redirect TCP traffic to destinations with ports: 80, 443, and 21 (FTP is on port 21).

In all modes, the proxy should first attempt a Passive connection to the server, and fall back to Active mode with a suitably random, high-numbered port, only accepting connections from the appropriate server.

In forward mode, the browser simply connects to the proxy and treats the FTP download as any other HTTP request. The proxy becomes the FTP client, and returns the content received back to the browser in an HTTP response. In Bridged Mode, the browser does not know it is dealing with a proxy, so it treats the proxy as an FTP server. The proxy channels both connections from the client to the FTP server and back. The content, delivered via the Data connection, will be treated with content-scanning and policy-management as with HTTP responses.

In an embodiment, the Control connection can be copied between the client and the server. The FTP proxy determines the IP address to which the client is attempting a connection. This enables the FTP proxy to perform a query to the reputation service 150 based on the IP address. The proxy must actually connect to the destination server (this requirement exists in HTTP proxy for bridged mode). A PASV command requires the proxy to respond with the correct IP address. In an embodiment, the Data connection is copied between the client and server.

The implementation and deployment considerations for L4 mode are_identical_to that of Bridged mode, with the following amendments. If Active mode (from the client to the proxy) will be supported, then the network topology must be configured to allow the proxy to connect directly to the client to support the PORT command in Active mode. To support Passive mode, a dedicated IP address (or CIDR range), that allocated to the proxy, is returned to the client after the PASV command. The L4 switch redirects all traffic to that IP to the proxy. This approach maintains the PASV mode. Alternatively, a special port range is used in which TCP traffic to a special range of ports (to any IP address) would be redirected to the proxy. In this approach, no dedicated IP address is used.

In an embodiment, the messaging gateway 608 is configured to generate security certificates as needed. As described herein, messaging gateway 608 has the ability to scan client-bound traffic for spyware. When the traffic is HTTPS, traffic flows are encrypted between the client and the server. The proxy functions as a “man in the middle (MITM)”—decrypting data from the server, scanning the data, then re-encrypting the data to pass on to the client. When HTTPS is performing both encryption and server authentication, the proxy needs (1) to masquerade as a server that can authenticate itself to the client, and (2) to function as an HTTPS client facing the real server. The second requirement is satisfied by having an HTTPS client implementation running on the proxy. To satisfy the first requirement, the proxy generates a self-signed certificate for the domain that the client requested. The proxy sends this certificate to the client in the Certificate message, allowing the client to authenticate the proxy as though the proxy were the real server.

The proxy can act as a MITM when HTTPS is providing only encryption. In that case, the proxy sends a ServerKeyExchange message to the client. This message contains a public key, which the client uses to encrypt symmetric key material that it sends back to the proxy in a ClientKeyExchange message. This symmetric key material is then used to encrypt data traffic.

A detailed description of approaches for the HTTP proxy to generate security certificates is provided in the priority provisional application.

In an embodiment, response body filtering begins when the response body is delivered completely to the proxy. In this embodiment the proxy sends the response to the client as it is received, so that only a small suffix, at best, of the response can be withheld once the response has been identified as harmful. Alternatively, the proxy allows sequential delivery of response data to a filtering agent to reduce the calculation time once the body is scanned completely. Appropriately establishing access policies at points during the delivery of the body to the proxy can eliminate the need for scanning more than a small prefix of the response in some cases. For example, whenever more response data becomes available to the proxy, there is the opportunity for partial response body scanning. If a transaction requires response body scanning, then newly available data is presented to the filtering engine, and when that engine reaches a conclusion on the value of response-body-based profiles, the access control policies can be reevaluated, and the transaction either terminated, or freed to proceed without more filtering.

In an embodiment, for a transaction that requires response body scanning, the response is buffered, so that small responses can be withheld from the client entirely until a verdict is rendered. Large responses are delivered, but not in their entirety; once the danger in the response is recognized, the buffered part of the response is dismissed without having been sent to the client, and the connection to the client can be terminated. While the verdict is unknown, the proxy will deliver content only when the filling of the fixed size response buffer makes it necessary. After the content is found to be acceptable, the buffered contents and the remainder of the response can be delivered to the client as quickly as possible.

In an embodiment, whenever more response data becomes available to the proxy for some transaction, the proxy updates response filtering data with information that identifies how much response body is currently available and the total response size, if that information is available. When filtering agents return to the proxy with requests for more data, the proxy can respond with data up to the limits imposed by the latest information. When filtering is complete, that information can be used immediately, either to terminate the transaction or to let it go on.

There are two potential benefits to this in-progress body scanning. If some body scanning tool requires, by its nature, a sequential scan of the complete response, then feeding the data to that tool faster means that when the response body is complete the tool can deliver its verdict faster. The other potential benefit is that some response body profiles might deliver their verdicts before the entire response body is available. To exploit this benefit will require a slight change in the use of the access control system, since it means that response body profiles become a new kind of profile that may be evaluated during a transaction phase, or may be evaluated after it, with different contexts for those two evaluations.

To withhold response data from the client until an access control decision is made, the implementation will modify the code that writes to client, to hold back some data when necessary, and the code that chokes the server when too much pending data is stored, to account for some of the pending data being due to response blocking.

Withholding all response data from the client until body filtering is complete is possible when the response can be saved and the transaction is not one that demands immediate data transmission to work. In these cases, the position of the last byte writable to the client will be adjusted by a fixed amount as long as the access decision remains unmade. This will delay the delivery of the response. When the response is complete, the last call to the response filterer should produce a final verdict. At that time, the proxy can let the transaction continue.

4.0 Implementation Mechanisms—Hardware Overview

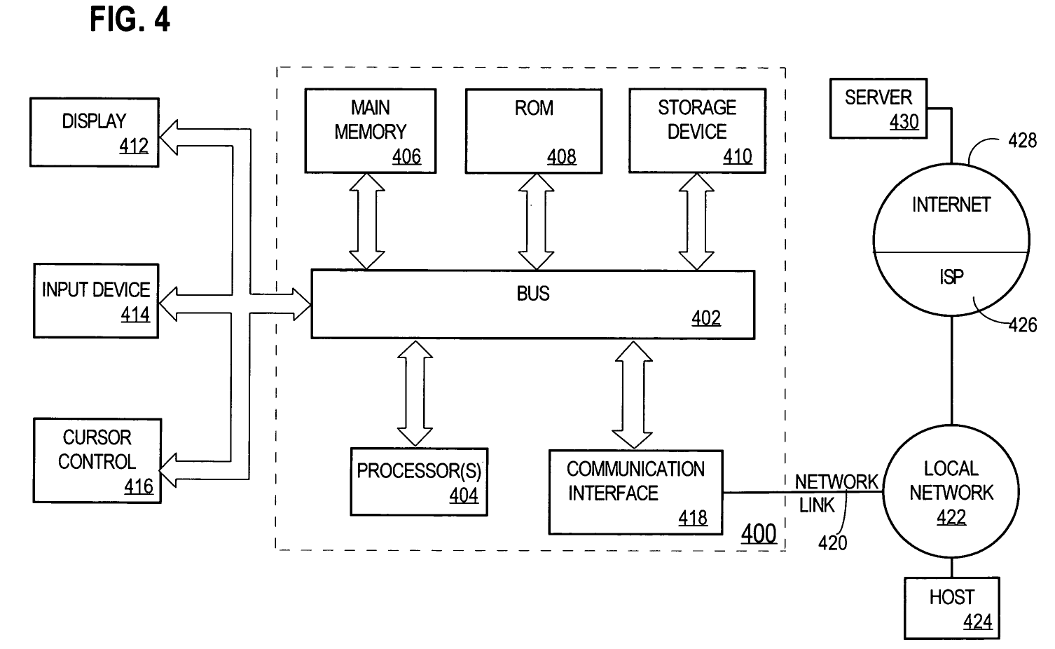

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (“RAM”) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (“ROM”) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (“CRT”), for displaying information to a computer user. An input device 414, including alphanumeric and other keys, is coupled to bus 402 for communicating information and command selections to processor 404. Another type of user input device is cursor control 416, such as a mouse, trackball, stylus, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for controlling access to network resources based on reputation. According to one embodiment of the invention, controlling access to network resources based on reputation is provided by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (“ISDN”) card or a modem to provide a data communication connection to a corresponding type of telephone line. As another example, communication interface 418 may be a local area network (“LAN”) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (“ISP”) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. In accordance with the invention, one such downloaded application provides for controlling access to network resources based on reputation as described herein.

The received code may be executed by processor 404 as it is received, and/or stored in storage device 410, or other non-volatile storage for later execution. In this manner, computer system 400 may obtain application code in the form of a carrier wave.

In an embodiment, computer system 400 comprises a Dell PE2850 server. In an embodiment, computer system 400 has the following characteristics:

| Feature | Configuration |
|---|---|
| Form Factor | 2U rack height |
| Processors | 1 or 2 Intel Xeon or Paxville Dual-core processors |
| Cache | 2 MB L2 |
| Memory | up to 12 GB DDR-2 400 SDRAM or 16 GB dual-rank |
| | DIMMs |
| I/O Channels | Two PCI-E slots (1 × 4 lane, 1 × 8 lane) and One |
| | PCI-X slot |
| HDDs | Up to 6 Ultra320 Hot-plug SCSI drives, 10K or |
| | 15K RPM |
| RAID Controller | Dual Channel ROMB (PERC 4e/Di) using RAID 10 |
| Networking | Dual embedded Intel Gigabit NICs (Data 1 & |
| | Data 2) |
| | Add'l 2- or 4- port Ethernet Bypass Card for |
| | redundancy |
| Power Supply | 700 W hot-plug redundant power, single and y-cord |
| Management | IPMI 1.5 compliance |
| Availability | Hot-swap PSU, HDD, Fans |

5.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. An apparatus, comprising:
one or more processors;
a first network interface that is coupled to a first network that includes a plurality of clients;
a second network interface that is coupled to a second network that includes a plurality of resources;
a computer-readable storage medium that comprises one or more stored sequences of instructions which, when executed by the processor, cause the processor to perform:
receiving a client request that includes a particular network resource identifier;
retrieving, from a database that associates a plurality of network resource indicators with attributes of the network resource identifiers, values of particular attributes that are associated with the particular network resource identifier;
determining a reputation score value for the particular network resource identifier based on the particular attributes;
performing a responsive action for the client request based on the reputation score value.

2. The apparatus of claim 1, wherein the client request is an HTTP request, wherein the network resource identifier is a URL.

3. The apparatus of claim 1, wherein the responsive action comprises denying access to a resource that is identified in the network resource identifier.

4. The apparatus of claim 1, wherein the responsive action comprises performing one or more other tests on resources or network resource identifiers.

5. The apparatus of claim 1, further comprising an HTTP proxy and an e-mail server.

6. The apparatus of claim 1, wherein the computer-readable medium further comprises instructions which when executed cause performing determining the reputation score value by:
providing the particular network resource identifier to a reputation service;
receiving a plurality of prefix reputation score values for each of a plurality of prefixes that form parts of the network resource identifier;
determining the reputation score value by combining and weighting the received prefix reputation score values.

7. An apparatus, comprising:
one or more processors;
a first network interface that is coupled to a first network that includes a plurality of clients;
a second network interface that is coupled to a second network that includes a plurality of resources;
means for receiving a client request that includes a particular network resource identifier;
means for retrieving, from a database that associates a plurality of network resource indicators with attributes of the network resource identifiers, values of particular attributes that are associated with the particular network resource identifier;
means for determining a reputation score value for the particular network resource identifier based on the particular attributes;
means for performing a responsive action for the client request based on the reputation score value.

8. The apparatus of claim 7, wherein the client request is an HTTP request, wherein the network resource identifier is a URL.

9. The apparatus of claim 7, wherein the responsive action comprises denying access to a resource that is identified in the network resource identifier.

10. The apparatus of claim 7, wherein the responsive action comprises performing one or more other tests on resources or network resource identifiers.

11. The apparatus of claim 7, further comprising an HTTP proxy and an e-mail server.

12. The apparatus of claim 7, further comprising:
means for providing the particular network resource identifier to a reputation service;
means for receiving a plurality of prefix reputation score values for each of a plurality of prefixes that form parts of the network resource identifier;
means for determining the reputation score value by combining and weighting the received prefix reputation score values.

13. An apparatus, comprising:
one or more processors;
a network interface that is coupled to a network that includes a plurality of resources;
a computer-readable storage medium that comprises one or more stored sequences of instructions which, when executed by the processor, cause the processor to perform:
receiving information about a plurality of network resource identifiers from one or more reputation data sources;
processing the network resource identifiers to determine a web reputation score value representing an overall probability that the network resource identifiers are associated with malware;
storing the web reputation score value in a database that associates a plurality of network resource indicators with attributes of the network resource identifiers;
repeating the receiving, processing, transforming and storing as new information becomes available for the same network resource identifiers.

14. The apparatus of claim 13, wherein the information about the plurality of network resource identifiers comprises any of how long the domain in a URL has been registered, what country the website is hosted in, whether the domain is owned by a Fortune 500 company, and whether the Web server is using a dynamic IP address.

15. The apparatus of claim 13, wherein the processing comprises evaluating one or more parameters selected from among the group consisting of: URL categorization data; the presence of downloadable code at a web site; the presence of long, obfuscated End User License Agreements (EULAs); global traffic volume and changes in volume; network owner information; history of a URL; age of a URL; the presence of a URL on a blacklist of sites that provide viruses, spam, spyware, phishing, or pharming; the presence of a URL on a whitelist of sites that provide viruses, spam, spyware, phishing, or pharming; whether the URL is a typographical corruption of a popular domain name; domain registrar information; IP address information.

16. The apparatus of claim 13, wherein the instructions when executed cause assigning a weight to each of the parameters.

17. The apparatus of claim 13, wherein the instructions when executed cause assigning a high weight to a parameter indicating the presence of URLs on a trusted blacklist, and assigning a low weight to network owner information from a “whois” database.

18. The apparatus of claim 13, wherein the computer-readable medium further comprises instructions which when executed cause performing determining the reputation score value by:
receiving the network resource identifiers from a messaging apparatus;
determining a plurality of prefixes that form parts of the network resource identifier;
submitting each of the prefixes to the reputation data sources;
receiving feed score values for the prefixes from the reputation data sources;
determining a plurality of prefix reputation score values for each of the prefixes based on the feed score values;
sending the prefix reputation score values to the messaging apparatus.

19. The apparatus of claim 18, wherein the computer-readable medium further comprises instructions which when executed cause performing determining the reputation score value by weighting the received prefix reputation score values based on source reputation values associated with the reputation data sources.

20.-37. (canceled)
